(19) United States
(12) Patent Application Publication
(10) Pub. No.: US 2009/0119604 A1
(43) Pub. Date: May 7, 2009

(54) VIRTUAL OFFICE DEVICES

(75) Inventors: Patrice Simard, Bellevue, WA (US); Ajitesh Kishore, Kirkland, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/935,549

(22) Filed: Nov. 6, 2007

(51) Int. Cl. G06F 3/048

(52) U.S. Cl. 715/757

(57) ABSTRACT

The claimed subject matter provides a system and/or a method that facilitates communicating data utilizing holographic representations. An interface component can receive a portion of data related to a virtual meeting. A holographic component can generate at least one holographic image within a virtual meeting space, wherein the holographic image can virtually represent at least one of the portion of data related to the virtual meeting or a user associated with the virtual meeting. Moreover, a share component can employ a public view or a private view for the holographic image within the virtual meeting space.

### BACKGROUND

Computing and network technologies have transformed many aspects of everyday life. Computers have become household staples rather than luxuries, educational tools and/or entertainment centers, and provide individuals and corporations with tools to manage and forecast finances, control operations such as heating, cooling, lighting and security, and store records and images in a permanent and reliable medium. Networking technologies like the Internet provide individuals virtually unlimited access to remote systems, information and associated applications.

As computing and network technologies have evolved and have become more robust, secure and reliable, more consumers, wholesalers, retailers, entrepreneurs, educational institutions and the like are shifting paradigms and are employing the Internet to perform business rather traditional means. For example, today consumers can access their bank accounts on-line (e.g., via the Internet) and can perform an ever growing number of banking transactions such as balance inquiries, fund transfers, bill payments, and the like. In addition, businesses and corporations typically manage meetings and schedules through the use of an electronic calendar application.

In general, business calendar applications typically include meetings and meeting details in which people discuss topics, subjects, and the like. Meetings are a common everyday occurrence especially for members of an organization. Groups of people often assemble to discuss one or more predetermined topics or issues. By way of example, there can be status meetings, budget meetings, staff meetings, product development meetings, patent disclosure meetings, and board meetings, among many others. Meetings are viewed by organizations as a crucial vehicle for facilitating communication amongst group members for the purpose of disseminating knowledge, problem solving, brainstorming and/or the like. Accordingly, many individuals spend a large portion of their time in meetings. In fact, business meetings are so pervasive that some joke that there needs to be a meeting solely to schedule the next meeting.

By leveraging the Internet and other networking technologies, physical attendance in business meetings has decreased in light of teleconferences, web-based meetings, virtual meetings, web-camera based meetings, application sharing meetings, and the like. For instance, a group of people across the globe can join a web-based meeting via the Internet in which web-cameras can provide images, sounds, and/or video. Yet, with the vast amount of technological advances, virtual meetings are constantly evolving to improving efficiency, usability, and realism.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate creating a virtual meeting space with meeting data including a public view or a public view for accessibility. A holographic component can represent at least one of a portion of meeting data or a user as a holographic image within a virtual meeting space in order to conduct a virtual meeting. For instance, a user and/or meeting data can be holographically represented within a virtual meeting space in which invitees (e.g., users, groups, etc.) can participate in a meeting independent of physical location. Furthermore, a share component can implement a data access definition in relation to at least one holographic image within the virtual meeting space, wherein such data access definition can be a granular level of access for each invitee within the virtual meeting. In other words, public and/or private views for holographic images within the virtual meeting space can be defined to enable a granular level of accessibility for a virtual meeting. In other aspects of the claimed subject matter, methods are provided that facilitate managing virtually re-created meeting data within a virtual meeting space with hierarchical data accessibility levels.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates creating a virtual meeting space with meeting data including a public view or a public view for accessibility.

FIG. 2 illustrates a block diagram of an exemplary system that facilitates managing virtually re-created meeting data within a virtual meeting space with hierarchical data accessibility levels.

FIG. 3 illustrates a block diagram of an exemplary system that facilitates interacting within a virtual meeting space by leveraging a device.

FIG. 4 illustrates a block diagram of an exemplary system that facilitates utilizing a virtual meeting space via a cloud service.

FIG. 5 illustrates a block diagram of exemplary virtual meeting that illustrates virtual meeting space and/or holographic images in accordance with the subject innovation.

FIG. 6 illustrates a block diagram of an exemplary system that facilitates online data collaboration within a virtual meeting space that includes granular levels of data accessibility.

FIG. 7 illustrates an exemplary methodology for creating a virtual meeting space with meeting data including a public view or a public view for accessibility.

FIG. 8 illustrates an exemplary methodology that facilitates managing virtually re-created meeting data within a virtual meeting space with hierarchical data accessibility levels.

FIG. 9 illustrates an exemplary networking environment, wherein the novel aspects of the claimed subject matter can be employed.

FIG. 10 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “interface,” “meeting,” “store,” “device,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

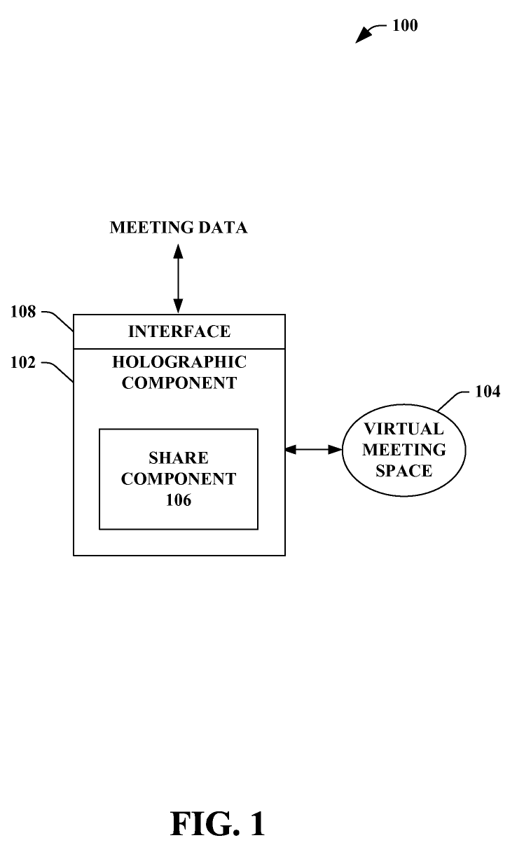

Now turning to the figures, FIG. 1 illustrates a system 100 that facilitates creating a virtual meeting space with meeting data including a public view or a public view for accessibility. The system 100 can include a holographic component 102 that can generate a holographic image within a virtual meeting space 104 for a portion of meeting data received via an interface component 108 (discussed in more detail below and also referred to as “the interface”). The holographic component 102 can virtually represent the portion of meeting data within the generated virtual meeting space 104, wherein a share component 106 can enable a granular accessibility for data. In general, the share component 106 can employ a public view or a private view for data within the virtual meeting space 104 that can allow restricted or unrestricted access to specific portions of data. In addition to representing meeting data as a holographic image within the virtual meeting space 104, the holographic component 102 can represent a user as a holographic image within the meeting space. In other words, the system 100 can generate at least one holographic image within a defined virtual meeting space, wherein the holographic image can be representative to at least one of a portion of meeting data or a user associated with a meeting.

As discussed, the holographic component 102 can receive meeting data via the interface 108 in order to generate a representative holographic image within the virtual meeting space 104. The virtual meeting space 104 can be any suitable environment (e.g., 2 dimension, 3 dimension, etc.) in which a user can interact with virtually represented data. For instance, the virtual meeting space 104 can be any suitable simulated location in which a meeting can be held such as, but not limited to, a virtually represented conference room, a conference room, an auditorium, a conference an on-site location, an off-site location, an inside location, an outside location, an office building, a conference center, a park, a construction site, etc. In general, the meeting data can relate to at least one of establishing connectivity between invitees within the virtual meeting (e.g., virtual meeting time, virtual meeting date, virtual meeting location/address, a listing of invitees, a context for the virtual meeting, a web link, a web site, an web address, an Internet Protocol (IP) address, a telephone number, a third-party conference service, a mobile communication number, etc.) or information that is to be distributed between invitees within the virtual meeting (e.g., presentation material, applications, data, etc.). Moreover, it is to be appreciated that the meeting data represented by holographic images can be, but is not limited to being, a virtual meeting location (e.g., Internet Protocol (IP) address, web link, web site, teleconference number, etc.), word processing documents, email, applications, instant messages, video, audio, slide shows, graphs, agendas, statistics, spreadsheet data, spreadsheet documents, invitee biography data, websites, a network, a server, a portion of remote data, a portion of local data associated with an invitee, time of meeting, list of invitees, topics/subjects of the meeting, invitee information (e.g., location, credentials, etc.), digital representation information related to an invitee (e.g., physical appearance, clothing, attire, jewelry, avatar, icon, background/backdrop, etc.), data links, web links, text, images, and/or any other suitable data that relates to a meeting or an invitee for a meeting.

For example, a virtual meeting can be scheduled for user A, user B, and user C in which speaker X is presenting a slide show on a particular topic. The meeting data (e.g., slide show, material, graphs, biographical information for invitees, agenda, schedule, etc.) can be virtually represented as holographic images. Moreover, the invitees can be represented as holographic images. In order to simulate a physical meeting environment, such holographic images can be employed with a defined virtual meeting space. Thus, user A, user B, user C, speaker X, meeting data, etc. can be virtually represented via holographic images within the virtual meeting space. The system 100 enables the virtually represented data to include hierarchical or granular levels for accessibility. In other words, data access can be managed within the virtual meeting space by invitees, administrators, etc. Therefore, a portion of data represented within the virtual meeting space can be public for invitees to view/access whereas a disparate portion of data virtually represented can be private for limited view/access. For instance, user A can define a portion of emails as private and a specific email as public since such specific email relates to the virtual meeting or particular topic.

In still another example, the subject innovation enables virtually represented users as well as virtually represented meeting data to be granularly accessible. Within a defined virtually meeting space, User A can be virtually represented by a holographic image and can enable a private view/setting related to another invitee (user B). Based on the private setting, user A as a virtual image within the meeting space will not be viewable by user B. The user or invitee virtual image privacy or public setting can be useful in a situation in which a superior wants to monitor a meeting without changing or affecting meeting flow or user demeanor. Thus, user A, user B, user C, and speaker X can be monitored within the virtual meeting space by a boss in order to gain a real and uninfluenced insight on the virtual meeting and/or users invited thereto. In another example, the privacy or public setting for a holographic image for a user/invitee can correlate with a corporate or business hierarchy (e.g., employee, manager, boss, etc.) which can allow automatic privacy and/or public settings to be implemented.

In addition, the system 100 can include any suitable and/or necessary interface 108, which provides various adapters, connectors, channels, communication paths, etc. to integrate the holographic component 102 into virtually any operating and/or database system(s) and/or with one another. In addition, the interface 108 can provide various adapters, connectors, channels, communication paths, etc., that provide for interaction with the holographic component 102, the share component 106, the virtual meeting space 104, meeting data, and any other device and/or component associated with the system 100.

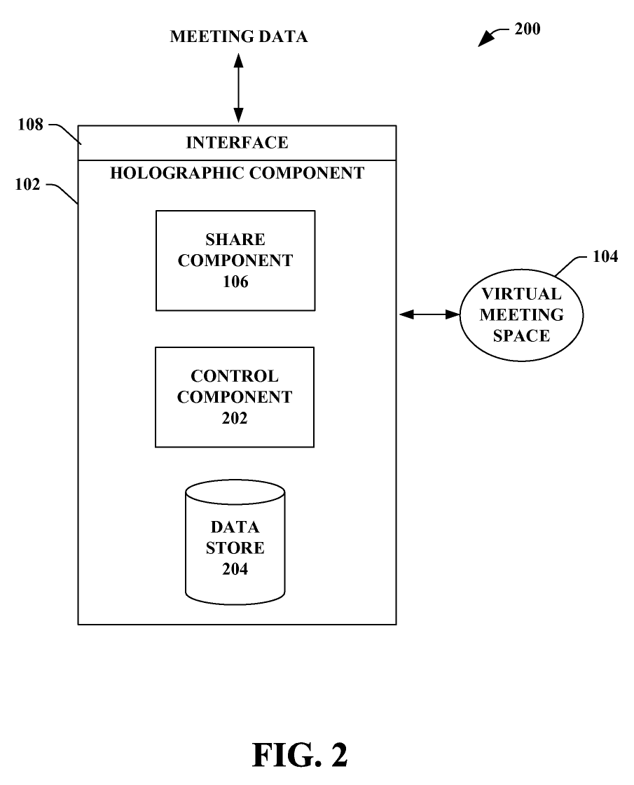

FIG. 2 illustrates a system 200 that facilitates managing virtually re-created meeting data within a virtual meeting space with hierarchical data accessibility levels. The system 200 can include the holographic component 102 that can generate a holographic image for a portion of meeting data or at least one user or invitee associated with a meeting. The holographic component 102 can create the virtual meeting space 104 in which such holographic images can be hosted in order to implement a virtual meeting. Moreover, the share component can enable a granular level of holographic image access within the virtual meeting space 104. In other words, a portion of meeting data or a user represented by a holographic image can include access levels (e.g., public, private, etc.) for each participant within the virtual meeting space.

For example, a user can be invited to a virtual meeting in which he or she is re-created as a holographic image within a virtual meeting space as well as any suitable data the user identifies as meeting data. The user can further define accessibility for the data and/or the holographic image representing him or her. Therefore, the user can select to represent email as a holographic image within the virtual meeting space and associated a private setting to such email which can restrict access or view of such email. In other words, the user can be in a virtual meeting space and take part in such meeting with virtual holographic images (based on private or public views/settings) while viewing email (also represented as a holographic image) privately.

The system 200 can further include a control component 202 that can employ management of data or users represented within the virtual meeting space as holographic images. In general, the control component 202 can allow a user in the physical world to control or manipulate data within the virtual meeting and/or the virtual meeting space. The control component 202 can further provide a model for how to control presentation of data. For instance, if a virtual meeting includes a plurality of people having discussions, such data within the virtual meeting can be controlled with hierarchical blending (e.g., value of information (VOI) calculation to increase volume of audio with importance, one-at-a-time technique, etc.), audio playback, video playback, user-specific replay of holographic images, user-controlled video/audio/data playback, etc. In addition, the control component 202 can provide user-specific controls related to data represented by holographic images. For instance, going back and forth between public data (e.g., slide show presentation given by a speaker, shared word processing document, etc.) and private data (e.g., emails, instant messenger, etc.).

The control component 202 can further enable changing dimension, perspective, moving holographic images within the virtual meeting space, etc. In other words, the control component 202 enables a user to manipulate at least one holographic image within the virtual meeting space, wherein the manipulation is at least one of a holographic image appearance (e.g., color, size, shape, etc.), a perspective, a dimension, or a characteristic related to receiving data from the virtual meeting (e.g., audio level, video playback, user settings, etc.). For instance, a white board can be a holographic image within a virtual meeting space in which invitees/users can access or view during a virtual meeting. The control component 202 can a first invitee to change the size (e.g., magnify, shrink, etc.) of the white board based on his or her liking. Moreover, as discussed, the whiteboard can include shared portions for a portion of invitees or users and/or a private portion which access is restricted, defined, or limited.

The control component 202 can also incorporate gestures or body motions to control or manipulate data within the virtual meeting space 104. For instance, a particular motion or movement can indicate moving a portion of data represented as a holographic image. In another example, a movement or gesture can be replicated with the holographic image representative of the user in the virtual meeting. It is to be appreciated that the control component 202 can provide interaction with any suitable data within the virtual meeting space 104, wherein each user or invitee can view such interactions with data or holographic images based on the pre-established or defined level of access (e.g., private, public, etc.).

The system 200 can further include a data store 204 that can include any suitable data related to the holographic component 102, the virtual meeting space 104, the interface 108, the control component 202, etc. For example, the data store 204 can include, but not limited to including, meeting data, user data, user preferences, security levels, public data, private data, passwords, meeting time, meeting location, invitees, meeting configuration (e.g., audio, video, leader setting, etc.), and/or any other suitable data related to a meeting, virtual meeting or a user associated with a meeting.

It is to be appreciated that the data store 204 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 204 of the subject systems and methods is intended to comprise, without being limited to, these and any other suitable types of memory. In addition, it is to be appreciated that the data store 204 can be a server, a database, a hard drive, a pen drive, an external hard drive, a portable hard drive, and the like.

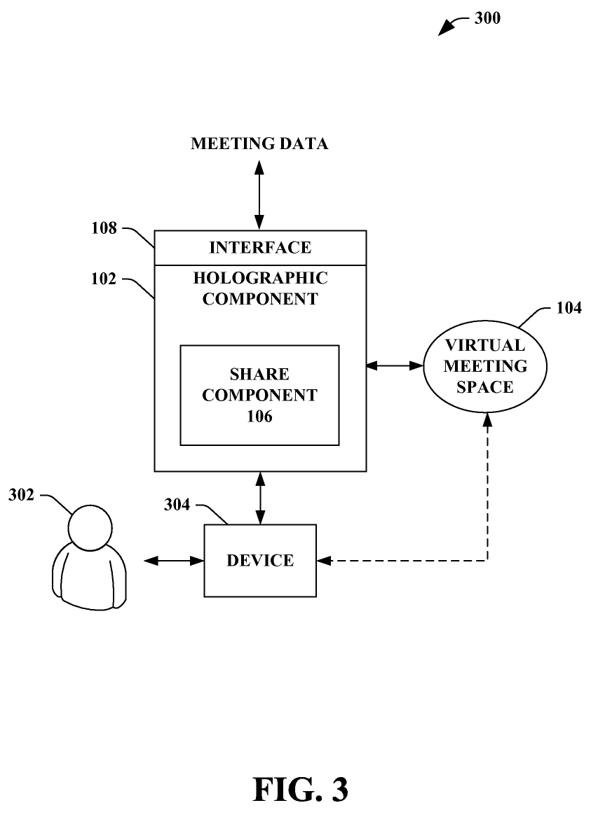

FIG. 3 illustrates a system 300 that facilitates interacting within a virtual meeting space by leveraging a device. The system 300 can include the holographic component 102 that can employ a holographic image for a portion of meeting data and/or a user, wherein such holographic images can interact with one another within a virtual meeting space for enhanced virtual meetings. The holographic images can further include a granular level of access by utilizing the share component 106, in which a holographic image can include a respective access setting or level such as, but not limited to, private, public, user-specific list of access, corporation or business hierarchy of authority, etc. Thus, a portion of data can be represented by a holographic image in which such image can be interacted with based upon the access setting defined. For example, a shared presentation document can include a universal share setting to allow all attendees to view and/or interact with such document within the virtual meeting, whereas a portion of local data for a specific user can be viewed/interacted with based on a private level (e.g., not accessible for all attendees, etc.).

The holographic component 102 can generate a holographic image for any suitable data related to a meeting or a user associated with such meeting. In particular, a user 302 can utilize a device 304 in order to manipulate and/or view data within the virtual meeting space 104. It is to be appreciated that the device 304 can be any suitable device (e.g., software, hardware, and/or any suitable combination thereof) such as, but not limited to, a screen, a display, a head set, a pair of glasses, a body motion detection environment, a monitor with a shutter open and close technique, a glove, a helmet, a body suite, and/or any other device that can bridge a physical environment with a virtual environment to provide interaction therewith. For instance, two screens can be utilized within a pair of glasses, wherein a display can be switched between each eye/screen in order to give an experience of a 3-D environment.

It is to be appreciated that various devices can be provided to facilitate communications in the virtual meeting space 104. Such devices can enable holographic meeting presentations in which participants are presented as holographically projected members and data feeds mixed in with such holographic experience. In one example, this can include polarized glasses that can utilize spatial video to provide convergence at many levels. Moreover, such devices can be used to see projections at many levels including 3-D. The device 304 can project virtual persons/users (e.g., such as user 302) and data utilizing various combinations of displays that can correlate with the control aspects of such data (e.g., various displays respective to type of controls or data manipulation). The device 304 can further include multiple functions based on the type of data interaction. For instance, a specific device can be utilized for note taking, reading, capturing data, data transport, data conversion, data transport to structured data, whiteboard capture, translation/conversion into text, document rendering, rendering based on device capabilities, etc. The device 304 can, as discussed, include capturing gestures, motions, and the like. A gesture adaptive device can capture gestures and provide outward context such as a communication grammar that is tailored to the device (e.g., emoticons, short cuts, human adaptation to modality of device, camera recording emotions, etc.).

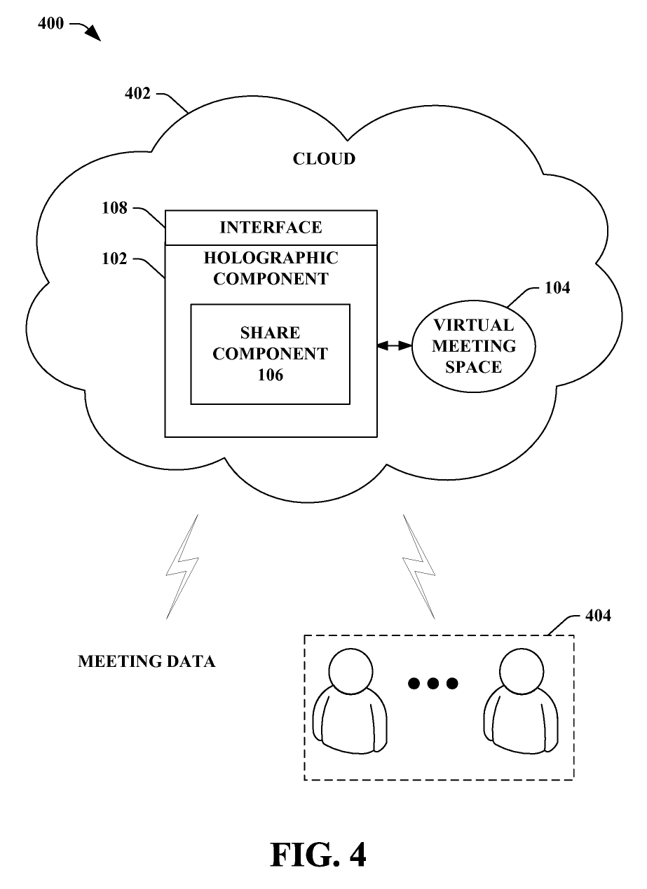

FIG. 4 illustrates a system 400 that facilitates utilizing a virtual meeting space via a cloud service. The system 400 depicts the holographic component 102 that can represent a portion of meeting data and/or a user as a holographic image within the virtual meeting space 104 for implementation of a virtual meeting. The system 400 can further employ data access on a granular level for holographic images by utilizing a share component 106. The share component 106 can provide at least one of a public view or a private view for holographic images (e.g., meeting data, users invited to a meeting, and/or any other data represented as a holographic image within the virtual meeting space 104). Moreover, such defined views can be specifically defined by each user/invitee in which each portion of data can include access settings for disparate users or invitees within the virtual meeting space 104. For instance, user A can include a document, an image, and an application that are represented as holographic images within a virtual meeting space. User A can further identify which portion of data can be public or private for each individual within the meeting. Thus, the document can be accessible (e.g., public) for user B and user C, whereas the image and the application can be non-accessible to user B and user C (e.g., but still accessible to user A based on ownership).

The system 200 can further utilize a cloud 402 that can incorporate at least one of the holographic component 102, the virtual meeting space 104, the share component 106, the interface 108, and/or any suitable combination thereof. It is to be appreciated that the cloud 402 can include any suitable component, device, hardware, and/or software associated with the subject innovation. The cloud 402 can refer to any collection of resources (e.g., hardware, software, combination thereof, etc.) that are maintained by a party (e.g., off-site, on-site, third party, etc.) and accessible by an identified user over a network (e.g., Internet, wireless, LAN, cellular, Wi-Fi, WAN, etc.). The cloud 402 is intended to include any service, network service, cloud service, collection of resources, etc. and can be accessed by an identified user via a network. For instance, two or more users 404 can access, join, and/or interact with the cloud 402 and, in turn, at least one of the holographic component 102, the virtual meeting space 104, the share component 106, the interface 108, and/or any suitable combination thereof. In addition, the cloud 402 can provide any suitable number of service(s) to any suitable number of user(s) and/or client(s). In particular, the cloud 402 can include resources and/or services that generate at least one holographic image based on meeting data and/or a user/invitee associated with a meeting. Moreover, the cloud 402 can include resources and/or services that enable data access on a granular level. For instance, the holographic component 102 and/or the share component 106 can be incorporated into the cloud 402 which can push and/or pull information (e.g., holographic images, controls, requests, public views, private views, etc.) to a user, a device, a machine, and/or any other suitable entity (e.g., business, corporation, enterprise, group of users, website, network, server, forum, collection of individuals, etc.).

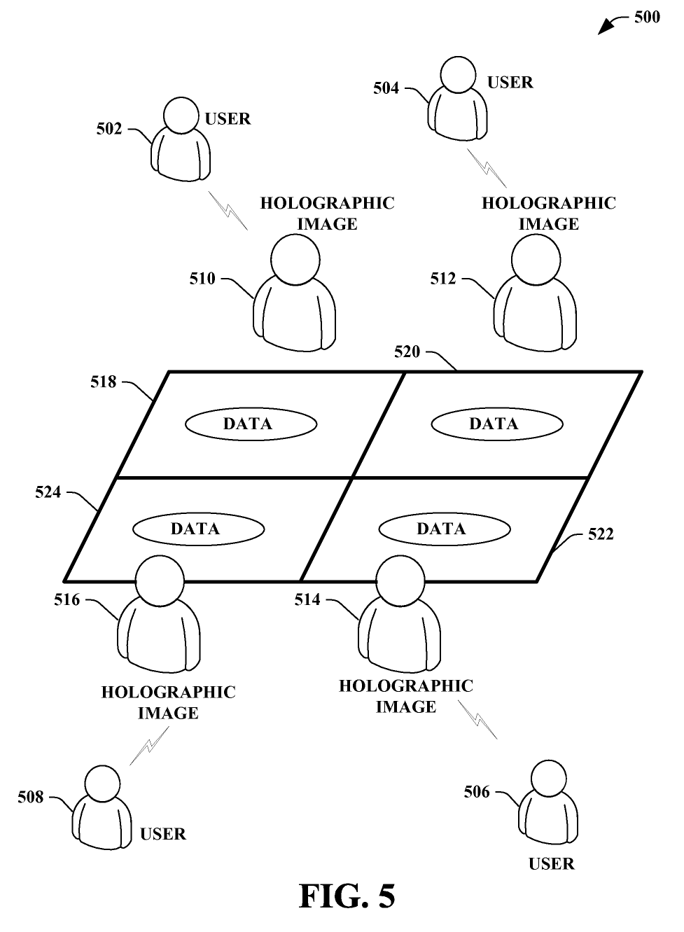

FIG. 5 illustrates a virtual meeting 500 that illustrates virtual meeting space and/or holographic images in accordance with the subject innovation. The virtual meeting 500 can include a number of users or invitees such as user 502, user 504, user 506, and user 508. Each user or invitee can be virtually represented within the virtual meeting 500 as a holographic image. For instance, user 502 can have a holographic image 510, user 504 can be simulated by a holographic image 512, user 506 can be represented by a holographic image 514, and user 508 can be virtually present with a holographic image 516. It is to be appreciated that the holographic images utilized to represent users or invitees can be user-defined, automatically generated, and/or any suitable combination thereof. For instance, user 502 can digitally create their own holographic image. In another example, a default holographic image can be utilized with identifying data (e.g., name tag, name, department, group of people, etc.).

The virtual meeting 500 can take place in any suitable virtual environment such as, but not including, a replicated digital environment (e.g., an office, an auditorium, a park, a convention center, a board room, etc.). The virtual meeting space can be, as depicted, a conference table in which a portion of the virtual meeting space is allocated to each invitee or user. As illustrated, user 502 is allocated virtual conference table space 518, user 504 is allocated virtual conference table space 520, user 506 is allocated virtual conference table space 522, and user 508 is allocated virtual conference table space 524. Moreover, each user or invitee can define access levels for each portion of data represented as a holographic image. For instance, each user or invitee can have holographic images representative of data (e.g., meeting data, user holographic image themselves, etc.) within each virtual conference table space. The user or invitee can identify data as public or private with settings associated therewith, wherein such data can be viewed (based on the privacy or public setting) within the virtual conference table space (e.g., virtual meeting space). For instance, a portion of data can be shared privately in a manner that an owner of such data is the only individual that can access such data within the virtual meeting 500. In another example, the portion of data can be public but limited to a select few of individuals or users. Generally, the holographic images and data represented therewith can include granular levels of access defined for each member, user, and/or invitee related to the virtual meeting.

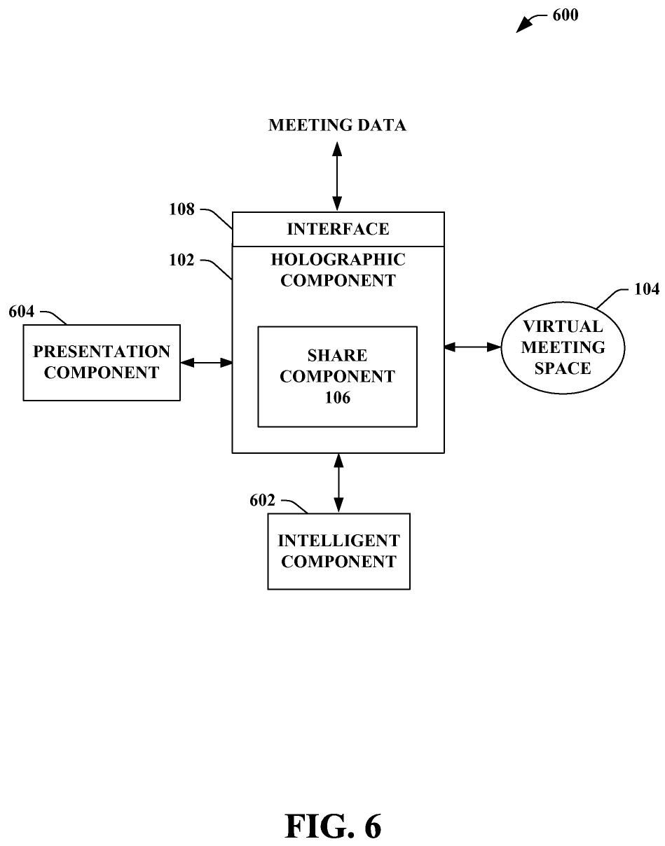

FIG. 6 illustrates a system 600 that employs intelligence to facilitate online data collaboration within a virtual meeting space that includes granular levels of data accessibility. The system 600 can include the holographic component 102, the virtual meeting space 104, the share component 106, and/or the interface 108. It is to be appreciated that the holographic component 102, the virtual meeting space 104, the share component 106, and/or the interface 108 can be substantially similar to respective components, spaces, and interfaces described in previous figures. The system 600 further includes an intelligent component 602. The intelligent component 602 can be utilized by the holographic component 102 to facilitate generating a holographic image for a portion of data related to a meeting and enabling granular data access for such holographic images. For example, the intelligent component 602 can infer holographic image representation, controls, virtual meeting space, virtual meeting environments, data access level, data access settings, data management and/or priority for specific users/invitees, required or suggested invitees for a meeting, user information, device settings, username, user preferences, etc.

The intelligent component 602 can employ value of information (VOI) computation in order to identify data priority for communication within a virtual meeting. For instance, by utilizing VOI computation, the most ideal and/or appropriate data can be communicated or prioritized for each individual within the meeting. Moreover, it is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The holographic component 102 can further utilize a presentation component 604 that provides various types of user interfaces to facilitate interaction between a user and any component coupled to the holographic component 102. As depicted, the presentation component 604 is a separate entity that can be utilized with the holographic component 102. However, it is to be appreciated that the presentation component 604 and/or similar view components can be incorporated into the holographic component 102 and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the holographic component 102.

The user can also interact with the regions to select and provide information via various devices such as a mouse, a roller ball, a touchpad, a keypad, a keyboard, a touch screen, a pen and/or voice activation, a body motion detection, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, EGA, VGA, SVGA, etc.) with limited graphic support, and/or low bandwidth communication channels.

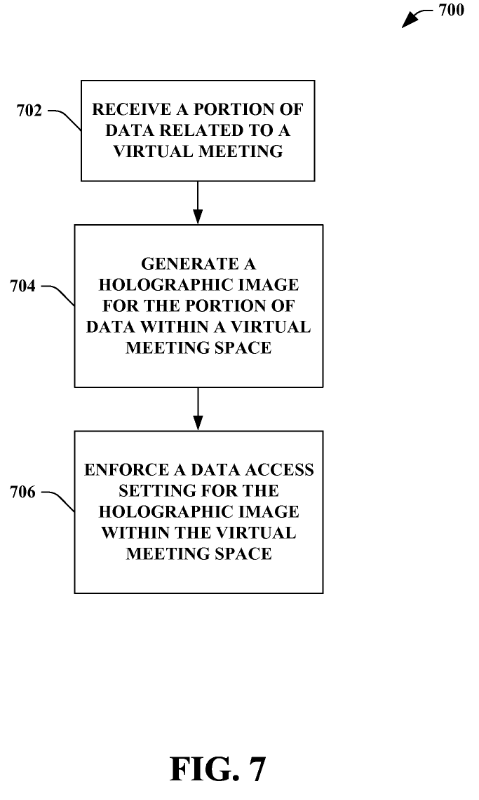

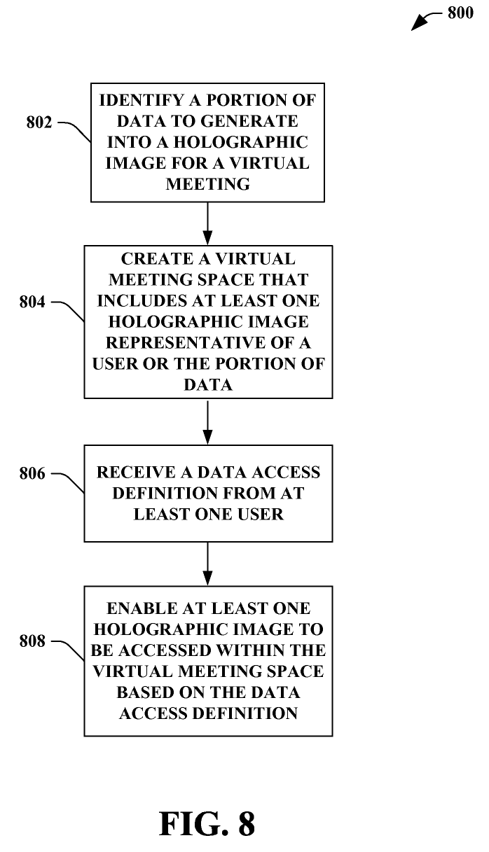

FIGS. 7-8 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a method 700 that facilitates creating a virtual meeting space with meeting data including a public view or a public view for accessibility. At reference numeral 702, a portion of data related to a virtual meeting can be received. It is to be appreciated that the portion of data related to a virtual meeting (e.g., meeting data, etc.) can be, but is not limited to being, a virtual meeting location (e.g., Internet Protocol (IP) address, web link, web site, teleconference number, etc.), meeting invitee, word processing documents, email, applications, instant messages, video, audio, slide shows, graphs, agendas, statistics, spreadsheet data, spreadsheet documents, invitee biography data, websites, a network, a server, a portion of remote data, a portion of local data associated with an invitee, time of meeting, list of invitees, topics/subjects of the meeting, invitee information (e.g., location, credentials, etc.), digital representation information related to an invitee (e.g., physical appearance, clothing, attire, jewelry, avatar, icon, background/backdrop, etc.), data links, web links, text, images, and/or any other suitable data that relates to a meeting or an invitee for a meeting. For example, meeting data can be received via a cloud and/or network in which a virtual meeting can be held.

At reference numeral 704, a holographic image can be generated for the portion of data within a virtual meeting space. In other words, the portion of data related to a virtual meeting can be represented as a holographic image within a virtual environment such as a virtual meeting space. For instance, a user or invitee can be invited to a virtual meeting, wherein such user can be represented as a holographic image within a virtual meeting space (e.g., virtual environment in which a virtual meeting can be held). Moreover, any suitable data related to the virtual meeting (e.g., documents, files, agenda, bio information, meeting location, images, audio, graphics, video, etc.) can be represented as a holographic image within the virtual meeting space. Thus, within a virtual meeting space, the virtual meeting can be initiated with users and/or any data related to the meeting based at least in part upon such users and/or data can be holographic images within the virtual meeting space.

At reference numeral 706, a data access setting for the holographic image within the virtual meeting space can be enforced, wherein the data access can include a private setting or a public setting. For instance, a portion of data related to a meeting (e.g., meeting data, documents, files, audio, video, users, etc.) can be represented by a holographic image and such image can include a setting which can define the access privileges for such holographic image during the virtual meeting within the virtual meeting space. In particular, a private setting can restrict data access within the virtual meeting space such that particular individuals or users holographically represented within the virtual meeting may not access. In addition, a public setting can allow particular individuals or users holographically represented within the virtual meeting to access such data or holographic imagery.

FIG. 8 illustrates a method 800 for managing virtually re-created meeting data within a virtual meeting space with hierarchical data accessibility levels. At reference numeral 802, a portion of data can be identified to generate into a holographic image for implementation into a virtual meeting. For example, in a virtual meeting request or in response to a request, data can be identified by an invitee for representation into holographic images within such virtual meeting. At reference numeral 804, a virtual meeting space can be created that includes at least one holographic image representative of at user or the portion of data identified.

At reference numeral 806, a data access definition can be received from at least one user. In particular, a user can select portions of data to holographically represent within a virtual meeting as well as define access (e.g., private, public, etc.) respectively. In one example, a user can identify portions of data to represent in a holographic image for a virtual meeting and provide access definitions for such data which can be enforced during the virtual meeting. Moreover, it is to be appreciated that the user can identify data to holographically represent within the virtual meeting well as provide access definitions at any suitable time for the virtual meeting (e.g., prior to the meeting, during the meeting, etc.). At reference numeral 808, access for at least one holographic image within the virtual meeting space can be enabled based upon the data access definitions. Thus, within the virtual meeting space, a holographic image representative of data associated with a meeting can be accessed in accordance to a user's definitions. In other words, a user can take part in a holographic virtual meeting with views corresponding to personal data (e.g., private data) as well as public data (e.g., data associated with the meeting).

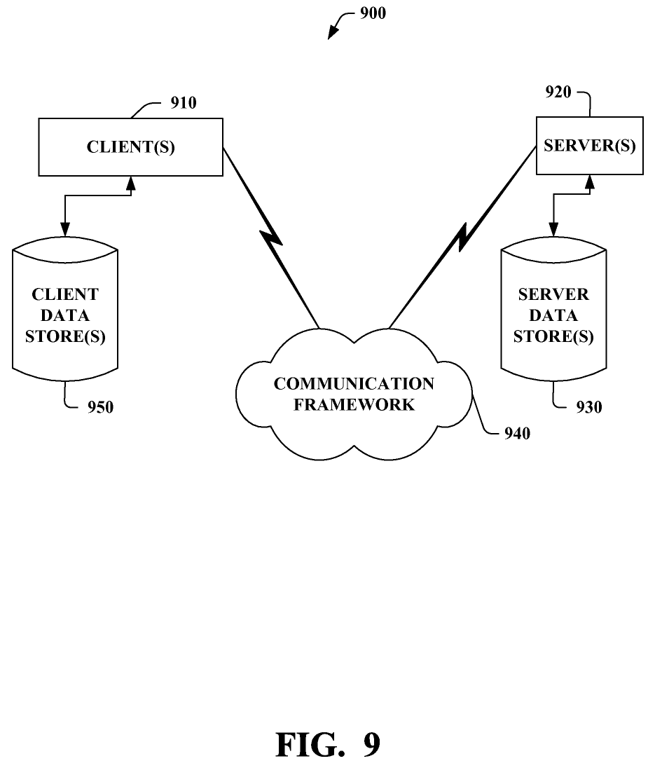

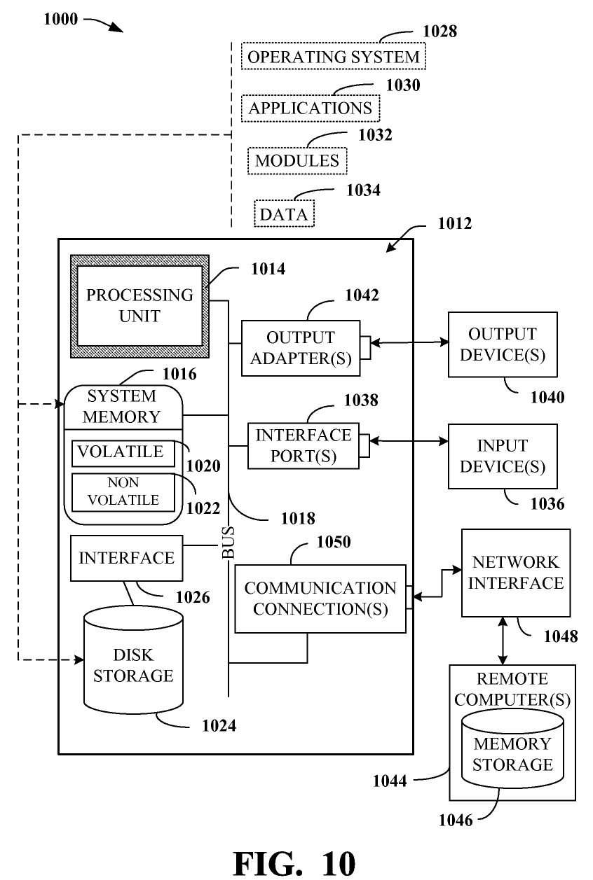

In order to provide additional context for implementing various aspects of the claimed subject matter, FIGS. 9-10 and the following discussion is intended to provide a brief, general description of a suitable computing environment in which the various aspects of the subject innovation may be implemented. For example, a holographic component can virtually represent a user and/or a portion of data in a virtual meeting space with private or public data accessibility, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 9 is a schematic block diagram of a sample-computing environment 900 with which the claimed subject matter can interact. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject innovation, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 950 that can be employed to store information local to the client(s) 910. Similarly, the server(s) 920 are operably connected to one or more server data store(s) 930 that can be employed to store information local to the servers 920.

With reference to FIG. 10, an exemplary environment 1000 for implementing various aspects of the claimed subject matter includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system that facilitates communicating data utilizing holographic representations, comprising:
an interface component that receives a portion of data related to a virtual meeting;
a holographic component that generates at least one holographic image within a virtual meeting space, the holographic image virtually represents at least one of the portion of data related to the virtual meeting or a user associated with the virtual meeting; and
a share component that employs at least one of a public view for the holographic image within the virtual meeting space or a private view for the holographic image within the virtual meeting space.

2. The system of claim 1, the virtual meeting space is an environment in the user interacts with the portion of virtually represented data.

3. The system of claim 2, the virtual meeting space is at least one of a two-dimensional environment, a three-dimensional environment, or a portion of a two-dimensional environment and a three-dimensional environment.

4. The system of claim 2, the virtual meeting space is a simulated location in which the virtual meeting is held and is at least one of a conference room, an office, an auditorium, a conference an on-site location, an off-site location, an inside location, an outside location, an office building, or a conference center.

5. The system of claim 1, the meeting data relates to at least one of establishing connectivity between invitees within the virtual meeting or information that is to be distributed between invitees within the virtual meeting.

6. The system of claim 5, the meeting data that relates to establishing connectivity between invitees within the virtual meeting is at least one of a virtual meeting time, a virtual meeting location, a virtual meeting data, a listing of invitees, a context for the virtual meeting, a telephone number, a third-party conference service, a mobile communication number, a web link, a web site, an web address, or an Internet Protocol (IP) address.

7. The system of claim 5, the meeting data related to information that is distributed between invitees within the virtual meeting is at least one of a word processing document, a portion of email, a portion of an application, a portion of an instant message, a portion of video, a portion of audio, a portion of a slide show, a graph, an agenda, a statistic, a portion of spreadsheet data, a spreadsheet document, a portion of invitee biography data, a website, a network, a server, a portion of remote data, a portion of local data associated with an invitee, a portion of invitee information, an invitee location, an invitee credential, a portion of digital representation information related to an invitee, a data link, a web link, a portion of text, or a portion of an image.

8. The system of claim 1, the share component dynamically implements at least one of the public view or the private view for data based at least in part upon an indication from the user.

9. The system of claim 1, the share component enforces at least one of the public view or the private view for the holographic image in which accessibility is defined for each invitee associated with the virtual meeting.

10. The system of claim 1, further comprising a control component that manages interaction between a user in the physical world and at least one holographic image within the virtual meeting space.

11. The system of claim 10, the control component prioritizes data communication within the virtual meeting space in a user-specific manner for each invitee.

12. The system of claim 10, the control component enables a user to manipulate at least one holographic image within the virtual meeting space, the manipulation is at least one of a holographic image appearance, a perspective, a dimension, or a characteristic related to receiving data from the virtual meeting.

13. The system of claim 10, the control component incorporates at least one of a body motion from a user in the physical world or a body gesture from a user in the physical world to interact with a holographic image within the virtual meeting space.

14. The system of claim 10, the control component utilizes a device to interact with at least one holographic image within the virtual meeting space, the device is at least one of a screen, a display, a head set, a pair of glasses, a body motion detection environment, a monitor with a shutter open and close technique, a glove, a helmet, a body suite, or a device that bridges a physical environment with a virtual environment to provide interaction therewith.

15. The system of claim 1, further comprising a cloud that incorporates at least one of the holographic component, the share component, or the interface component.

16. The system of claim 15, the cloud is a collection of resources maintained by a party and accessible by an identified user over a network.

17. A computer-implemented method that facilitates communicating information within a virtual meeting on a granular level, comprising:
receiving a portion of data related to a virtual meeting;
generating a holographic image for the portion of data within a virtual meeting space; and
enforcing a data access setting for the holographic image within the virtual meeting space.

18. The method of claim 17, further comprising:
identifying a portion of data to generate a holographic image for implementation within the virtual meeting space; and
receiving a data access definition from for the holographic image.

19. The method of claim 17, the virtual meeting space is an environment in the user interacts with the portion of virtually represented data.

20. A computer-implemented system that facilitates employing a virtual meeting between two or more users, comprising:
means for receiving a portion of data related to a virtual meeting;
means for generating at least one holographic image within a virtual meeting space;
means for representing at least one of the portion of data related to the virtual meeting or a user associated with the meeting with the holographic image; and
means for employing at least one of a public view for the holographic image within the virtual meeting space or a private view for the holographic image within the virtual meeting space.
